(19) United States
(12) Patent Application Publication
(10) Pub. No.: US 2024/0369998 A1
(43) Pub. Date: Nov. 7, 2024

(54) GATEWAY DEVICE AND METHOD FOR COMMUNICATION BETWEEN AN INDUSTRIAL AUTOMATION FACILITY AND A REMOTE SERVER

(71) Applicant: Siemens Aktiengesellschaft, München (DE)

(72) Inventors: Prashant Madhav Adkoli, Nürnberg (DE); Veysel Ufuk Ercin, Istanbul (TR); Gaurav Gupta, Pune (IN)

(21) Appl. No.: 18/141,896

(22) Filed: May 1, 2023

(30) Foreign Application Priority Data
Nov. 7, 2022 (JP) 20 2022 106 238.2

(51) Int. Cl. G05B 19/418; H04L 67/12

(52) U.S. Cl. CPC G05B 19/41855; H04L 67/12

(57) ABSTRACT

Provided is a gateway device for communication between an industrial automation facility and a remote server, the gateway device including, a hybrid communication interface including a Message Queuing Telemetry Transport client and Hypertext Transfer Protocol Secure-based component, memory to store a machine-readable instruction, and processing unit having one or more processors, configured to invoke the machine-readable instruction for sending data from one or more IoT Devices and/or one or more Data Historians in the industrial automation facility to the remote server using the hybrid communication interface, the hybrid communication interface is configured to receive a request for an Authorization Token from at least one of the Data Historian and the IoT Devices, and enable communication between at least one of the Data Historian and the IoT Devices, with one or more applications hosted on the remote server based on authentication of the AT request.

### CROSS-REFERENCE TO RELATED APPLICATIONS

This application claims priority to DE Application No. 20 2022 106 238.2, having a filing date of Nov. 7, 2022, the entire contents of which are hereby incorporated by reference.

Independent of the grammatical term usage, individuals with male, female or other gender identities are included within the term.

### FIELD OF TECHNOLOGY

The following relates to a gateway device. Particularly, the following relates to enabling bi-directional communication between the industrial automation facility and application hosted on the remote server.

### BACKGROUND

Gateway devices include multiple communication interfaces to communicate with IoT Devices in the industrial automation facility and the remote server. In some scenarios Message Queuing Telemetry Transport (MQTT) is used by the gateway device. MQTT is a broker-based message transport protocol. MQTT protocol lets the Publisher and Subscribers to exchange data as defined message size. This limits the amount of data that one can exchange with one message. Therefore, when large amount of data needs to be exchanged, different mechanisms are adopted. One such mechanism is setting the count of total number of message counts and labelling the sequence number in the message. Since the underneath network does not guarantee that the messages arrive in sequence that it is sent, it requires careful engineering. Accordingly, MQTT is not suitable for scenarios where large files need to be sent from the industrial automation facility to the remote server. With the development of the Internet of Things the need to transfer historical data from a Data Historian in the industrial automation environment may become a necessity. Accordingly, the MQTT protocol in itself cannot satisfy requirements in current Internet of Things communication.

### SUMMARY

There is therefore a need for an improved gateway device capable of providing efficient, secured bidirectional communication across applications and IoT devices.

An aspect relates to provide a gateway device that enables applications and IoT devices to asynchronously communicate with each other without compromising on security to exchange data with reduced infrastructure cost and maintenance. The gateway device is further capable of send large volumes of data between the applications and the IoT devices using the MQTT protocol, without additional effort to engineer the received data.

In an example of embodiments of the present invention, the aspect of embodiments of the present invention is achieved by a gateway device for communication between an industrial automation facility and a remote server, the gateway device comprising a hybrid communication interface comprising a Message Queuing Telemetry Transport (MQTT) client and Hypertext Transfer Protocol Secure (HTTPS)-based component; memory to store a machine-readable instruction; and processing unit having one or more processors, configured to invoke the machine-readable instruction for sending data from one or more IoT Devices and/or one or more Data Historians in the industrial automation facility to the remote server using the hybrid communication interface, the hybrid communication interface is configured to: receive a request for an Authorization Token (AT) from at least one of the Data Historian and the IoT Devices, and enable communication between at least one of the Data Historian and the IoT Devices to applications (APPs 1-3) hosted on the remote server based on authentication of the AT request.

In another example, the aspect is achieved by a method of communication between an industrial automation facility and a remote server using the gateway device. The method comprising establish a MQTT-based connection between the Data Historian, IoT Devices and the gateway device via the MQTT client; receiving a request for an Authorization Token (AT) from at least one of the Data Historian and the IoT Devices; receiving the authenticated AT by the gateway device, wherein the authenticated AT is a device certificate published from the remote server, wherein the MQTT client refers the authenticated AT to transmit historical data from the Data Historian using HTTPS Application Programming Interfaces (APIs); and enabling communication between at least one of the Data Historian and the IoT Devices with applications (APPs 1-3) hosted on the remote server based on the authenticated AT.

Before describing embodiments of the suggested invention in more detail, it should be understood that various definitions for certain words and phrases are provided throughout this patent document, and those of ordinary skill in the art will understand that such definitions apply in many, if not most, instances to prior as well as future uses of such defined words and phrases. It should also be appreciated that features explained in the context of the suggested method may also be comprised by the suggested system by appropriately configuring and adapting the system and vice versa.

As used herein “industrial automation facility” refers to a facility that for manufacture, production that may be semi or completely automated. For example, industrial automation facilities may include laboratory facility, building facility, a manufacturing facility and the like. The industrial automation facility may also refer to a combination of the aforementioned facilities.

The characteristic of an industrial automation facility is that it includes machines that are cyber-physical devices that are capable of communicating to a remote server. Further industrial automation facilities include sensors and actuators that are capable of communicating with the gateway device applications on the remote server. These devices are referred to as IoT devices.

The advantage of embodiments of the present invention is that the IoT Devices and the Data Historian are authenticated and authorized in a single step. Further, embodiments of the present invention provide bidirectional communication service using MQTT protocol to the applications and devices. Secured and efficient exchange of data between devices and the remote server. Embodiments of the present invention achieve the aforementioned advantages by using the hybrid communication interface comprising the HTTPS-based component and the MQTT client.

### BRIEF DESCRIPTION

Some of the embodiments will be described in detail, with reference to the following figures, wherein like designations denote like members, wherein:

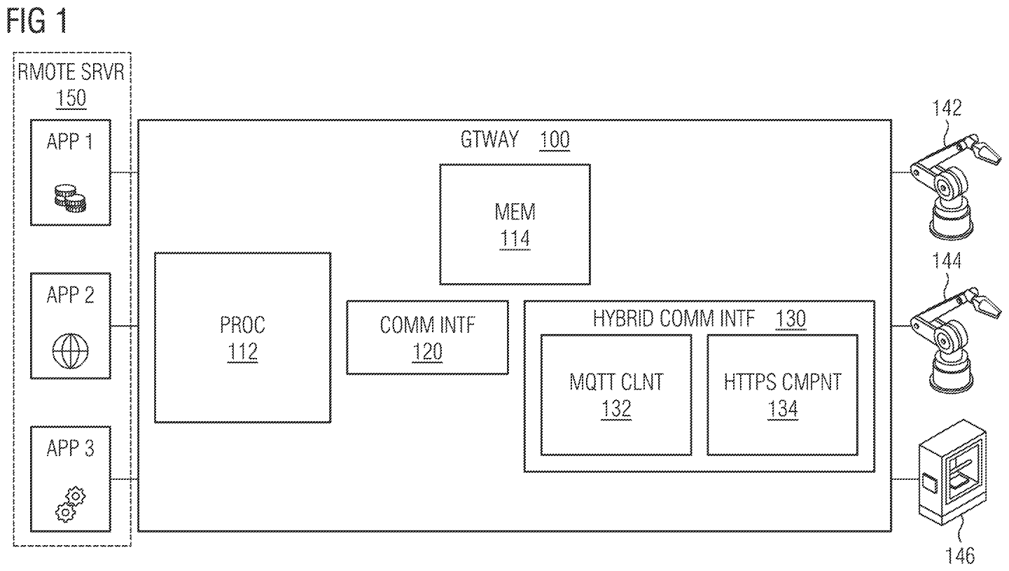

FIG. 1 illustrates a gateway device for bidirectional communication across applications, the Data Historian and the IoT devices, according to an embodiment of the present invention;

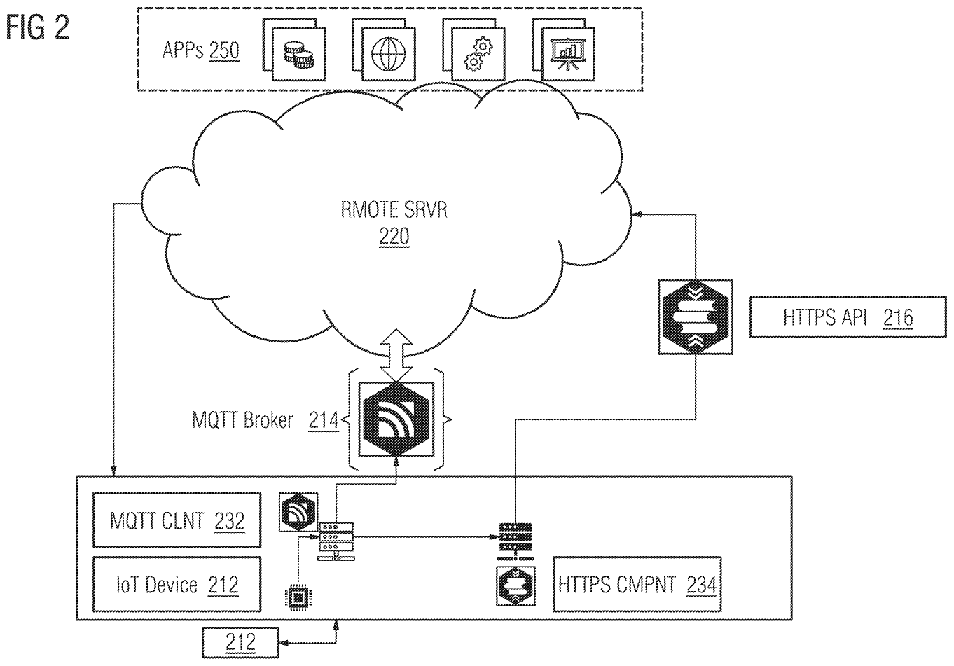

FIG. 2 illustrates bi-directional communication between an IoT Device and the application, according to an embodiment of the present invention; and

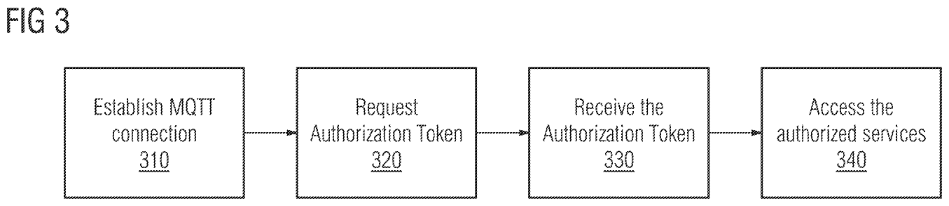

FIG. 3 illustrates a method of communication between an industrial automation facility and a remote server using the gateway device, according to an embodiment of the present invention.

### DETAILED DESCRIPTION

Hereinafter, embodiments for carrying out embodiments of the present invention are described in detail. The various embodiments are described with reference to the drawings, wherein like reference numerals are used to refer to like elements throughout. In the following description, for purpose of explanation, numerous specific details are set forth to provide a thorough understanding of one or more embodiments. It may be evident that such embodiments may be practiced without these specific details.

FIG. 1 illustrates a gateway device 100 for bidirectional communication across applications Apps 1-3, the Data Historian 146 and the IoT devices 142, 144, according to an embodiment of the present invention. The Apps 1-3 are hosted on a remote server 150.

The gateway device 100 includes a processor 112, a memory 114, a communication interface 120 and a hybrid communication interface 130. The memory 114 stores machine-readable instructions and the processing unit 112 having one or more processors, configured to invoke the machine-readable instructions for sending data from the IoT Devices 142, 144 in the industrial automation facility and/or the Data Historian 146 to the remote server 150 using the hybrid communication interface 130. The communication interface 120 may be an ethernet interface for communicating with Time Sensitive Networks (TSN).

The hybrid communication interface 130 further includes a Message Queuing Telemetry Transport (MQTT) client 132 and a Hypertext Transfer Protocol Secure (HTTPS)-based component 134. The MQTT client 132 may be implemented as a device comprising a microcontroller capable of executing a MQTT library and connects to a MQTT broker. In another embodiment, the MQTT client 132 is a software client that includes machine readable instructions, when executed by the processor the gateway device 100 is able to communicate in the MQTT protocol to connect to the MQTT broker.

The HTTPS-based component 136 may be implemented as a device capable of communicating with the remote server 150 in the HTTP over Secure Sockets Layer (SSL) or Transport Layer Security (TLS) protocols using Application Programming Interface (API) calls. In another embodiment, the HTTPS-based component 134 is a software module that includes machine readable instructions, when executed by the processor the MQTT client 132 is able to communicate with the remote server 150 via the HTTPS-based component 134. The HTTPS-based component 134 enables data from the IoT Devices 142, 144 and/or the Data Historian 146 to transmitted to the remote server 150 using the HTPPS API calls while using the MQTT protocol.

The gateway device 100 advantageously combines the capabilities of the MQTT protocol and the HTTPS to send data between the applications Apps 1-3 and the IoT Devices 142, 144, and the Data Historian 146. Therefore, applications and devices (IoT Devices 142, 144 and Data Historian 146) can asynchronously communicate with each other without compromising on security to exchange data with reduced infrastructure cost and maintenance.

FIG. 2 illustrates bi-directional communication between an IoT Device 212 and applications 250, according to an embodiment of the present invention. As shown in FIG. 2, a gateway device 200 comprising a MQTT client 232 and a HTTPS-based component 234. In an embodiment, the gateway device 200 includes an IoT Device 212 such as a sensor to monitor operating conditions of the industrial automation facility. In another embodiment, the IoT Device 212 may be provided as a separate device within the network of the gateway device 200. Also shown in FIG. 2 is a remote server 220 that hosts the applications 250. To access the remote server 220, the gateway device 200 uses an MQTT Broker 214. Further, communication with the remote server 220 is performed using HTTPS API calls.

The method of bi-directional communication is illustrated in FIG. 3, according to an embodiment of the present invention. At step 310 a MQTT connection is established between the IoT device 212 and the gateway device 200 via the MQTT client 232 and the MQTT broker 214. MQTT connection is established when the MQTT client 232 sends a message requesting connection to the MQTT Broker 214 and in response the MQTT Broker 214 sends an acknowledgment message and a status code. In an embodiment, when the message requesting connection to the MQTT Broker 214 is sent, the MQTT Broker 214 requests authentication of the IoT Device 212 with the remote server 220 using API calls.

Once the MQTT connection is established, at step 320 a request for an Authorization Token (AT) from the IoT Device 212 is received by the gateway device 200. For example, the MQTT client 232 receives the request for the Authorization Token AT. In response to the request, at step 330, the gateway device 200 receives the authenticated. The authenticated AT is a device certificate for the IoT Device 212 published from the remote server 220. The MQTT client 232 refers the authenticated AT to transmit data from the IoT Device 212 using HTTPS APIs. The HTTPS component 234 with the MQTT client 232 enables the IoT Device 212 to obtain the Authorization Token securely and access the HTTPS APIs without any additional authentication requirement. Therefore, the gateway device 200 enables zero-touch configuration of the IoT Device 212.

By enabling access to the HTTPS APIs, at step 340, communication between the IoT Device 212 with applications 250 is enabled. Enabling communication includes publishing asset models asynchronously from the MQTT client 212 and/or the IoT Device 212 in the field. Further, exchange of events and files between the applications 250 and the IoT Device 212 is possible.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

The claims are as follows:

1. A gateway device for communication between an industrial automation facility and a remote server, the gateway device comprising:
a hybrid communication interface comprising a Message Queuing Telemetry Transport (MQTT) client and Hypertext Transfer Protocol Secure (HTTPS)-based component;
a memory to store a machine-readable instruction; and
a processing unit having one or more processors, configured to invoke the machine-readable instruction for sending data from one or more Internet of Things (IoT) Devices and one or more Data Historians in the industrial automation facility to the remote server using the hybrid communication interface,
wherein the hybrid communication interface is configured to:
receive a request for an Authorization Token (AT) from at least one of the Data Historians and the one or more IoT Devices, and
enable communication between at least one of the Data Historians and at least one of the IoT Devices, with one or more applications hosted on the remote server based on authentication of the AT request.

2. The gateway device according to claim 1, further comprising:
an ethernet interface for communication with Time Sensitive Networks.

3. The gateway device according to claim 1, wherein the processing unit is configured to:
enable asynchronous communication between the applications and the IoT Devices, and the Data Historian using asynchronous Application Programming Interface (API) calls from the MQTT client and the applications.

4. The gateway device according to claim 1, wherein the processing unit is configured to:
receive an authenticated AT from the remote server in response to the request for the AT, wherein the authenticated AT is a device certificate published from the remote server for the IoT Devices and the Data Historian, wherein the MQTT client refers the authenticated AT to transmit historical data from the Data Historian using APIs.

5. The gateway device according to claim 1, wherein the processing unit is configured to:
enable the MQTT client to use HTTPS Application Programming Interfaces using the HTTP-based component based on the authentication of the AT.

6. The gateway device according to claim 1, wherein the processing unit is configured to:
transmit historical data from the Data Historian received by the MQTT client to the remote server, wherein the historical data comprises data associated with the industrial automation facility.

7. The gateway device according to claim 1, wherein the processing unit is configured to:
enable publication of asset models asynchronously by the MQTT client based on the authenticated AT, wherein the asset models include data models associated with the IoT Devices and the Data Historian, wherein the asset models define a transmission format of the data transmitted to the remote server.

8. The gateway device according to claim 7, wherein the processing unit is configured to:
publish the asset models by the MQTT client to the remote server via the HTTPS APIs.

9. The gateway device according to claim 1, wherein the processing unit is configured to:
onboard a new data source based on the AT published from the remote server, wherein the new data source includes an IoT Device or a Data Historian, wherein a request for AT from the new data source is authorized upon publication of the AT, wherein the new data source is in a facility network in which the IoT Device and the Data Historian are present.

10. A method of communication between an industrial automation facility and a remote server using the gateway device, the method comprising:
establishing a Message Queuing Telemetry Transport (MQTT)-based connection between the a Data Historian and Internet of Things (IoT) Devices and the gateway device via a MQTT client;
receiving a request for an Authorization Token (AT) from at least one of the Data Historian and the IoT Devices;
receiving an authenticated AT by the gateway device, wherein the authenticated AT is a device certificate published from the remote server, wherein the MQTT client refers the authenticated AT to transmit historical data from the Data Historian using Hypertext Transfer Protocol Secure (HTTPS) Application Programming Interfaces; and
enabling communication between at least one of the Data Historians and at least one of the IoT Devices with applications hosted on the remote server based on the authenticated AT.

11. The gateway device according to claim 1, wherein the hybrid communication interface is further configured to:
authenticate and authorize the one or more IoT Devices and the at least one of the Data Historians in a single step.
